(19) United States
(12) Patent Application Publication
(10) Pub. No.: US 2026/0243238 A1
(43) Pub. Date: Aug. 20, 2026

(54) HALL-EFFECT PROPULSION DEVICE WITH MAGNETIC COMPENSATION

(71) Applicant: EXOTRAIL, Massy (FR)

(72) Inventors: Alexandre GUGLIELMI, Chilly Mazarin (FR); Paul LASCOMBES, Fontenay Aux Roses (FR)

(21) Appl. No.: 19/489,529

(22) PCT Filed: May 30, 2024
(86) PCT No.: PCT/FR2024/050693

§ 371 Date: Dec. 2, 2025

(30) Foreign Application Priority Data
Jun. 9, 2023 (FR) FR2305876

(51) Int. Cl. F03H 1/00

(52) U.S. Cl. CPC F03H 1/0081

(57) ABSTRACT

A Hall-effect propulsion device including a support body extending between a first end and a second end said body comprising an annular external wall and an annular internal wall arranged coaxially about a longitudinal axis AA′ to form an annular duct, said first end having an annular opening forming an ion outlet;—a magnetic circuit arranged in the annular duct and configured to generate a radial magnetic barrier in the annular duct near the first end of the duct and—at least one magnetic compensation magnetic element arranged in said magnetic circuit and configured to compensate at least a fraction of an absolute value of the residual magnetic moment generated by said magnetic circuit.

### CROSS-REFERENCE TO RELATED APPLICATIONS

This application is a National Stage of International Application No. PCT/FR 2024/050693, having an International Filing Date of 30 Apr. 2024, which designated the United States of America, and which International Application was published under PCT Article 21(2) as WO Publication No. 2024/252084 which claims priority under 35 USC § 119(e) of French Patent Application No. 2305876, filed on Jun. 9, 2023, the disclosures of which are hereby incorporated by reference in their entireties.

### BACKGROUND

### Field

The present disclosure relates to the field of ion ejection devices, in particular for forming plasma thrusters or electric thrusters.

The present disclosure relates more particularly to a Hall-effect plasma propulsion device with magnetic compensation.

### Brief Description of Related Developments

In the field of space propulsion, it is well known to use electric or plasma thrusters to maintain a satellite in geostationary orbit, or to move a satellite between two orbits, or to compensate for drag forces on satellites placed in what is referred to as a low Earth orbit, or for missions requiring low thrust over very long times during an interplanetary mission. Specifically, plasma thrusters are able to generate a generally higher specific impulse than chemical thrusters, which implies a reduction in fuel (also known as propellant) consumption with the consequence of an increase in the lifetime and/or the payload of the satellites.

There are several types of plasma thrusters that differ according to how the plasma is ignited and how the plasma is accelerated toward the outlet of the ejection duct. Plasma thrusters can notably be classified into three main categories: electrothermal thrusters, electrostatic thrusters and electromagnetic thrusters.

Electrothermal thrusters use the Joule effect to heat the gas, which is then accelerated. The thruster known as an “arc-jet” thruster uses electric arcs formed between a central cathode and an external anode to heat the gas and cause the ignition of the plasma. Mention may also be made of the Radio Frequency (RF) thruster which belongs to this category.

Electromagnetic thrusters use Lorentz force to accelerate the plasma. In this category, mention may be made, for example, of the thruster known as a magnetoplasmadynamic thruster, which consists of a metallic coaxial discharge source of which the central conductor is the cathode and the external conductor is the anode. The potential difference applied between the anode and the cathode makes it possible to create a plasma between these electrodes. Simultaneously, the strong current flowing through them induces an azimuthal magnetic field around each electrode. Thus, the coupling between the radial electric field and the azimuthal magnetic field in the cavity creates a Lorentz force which propels the plasma axially toward the outlet.

In the family of electromagnetic thrusters, mention may also be made of magnetic-nozzle cathodeless thrusters. Mention may be made, for example, of the electron cyclotron resonance (ECR) thruster in which magnetized free electrons in the plasma enter into gyromagnetic resonance. In this family, the plasma is accelerated by the magnetic nozzle concept.

Electrostatic thrusters are based on the acceleration of ions in a plasma by means of an electric-field gradient toward the outlet of the ejection duct. Thrusters known as Hall-effect plasma thrusters belong to this category.

All these thrusters typically use coils and/or permanent magnets to produce a magnetic field that participates in the acceleration process by confining the electrons to the cavity known as the ionization chamber.

By way of example and with reference to FIG. 1, the operation and structure of a conventional Hall-effect plasma thruster assembly 1 is described in greater detail below.

The Hall-effect thruster assembly 1 comprises a magnetic circuit 20 and a support body 10.

The support body 10 has a shape exhibiting symmetry of revolution about a longitudinal axis AA′. The support body 10 comprises an annular duct 11 in which the magnetic circuit 20 is housed. The propulsion assembly comprises a first end 2 having an annular opening, and a second end 3. The interior surfaces of the annular duct 11 are provided with walls 26, 27 making it possible to physically delimit the ionization and acceleration zone. The walls are, for example, made of ceramic material.

The magnetic circuit 20 is formed by high positive magnetic susceptibility elements 21A, 21B, 24A, 24B and magnetic field generating permanent magnets 22, 23 arranged in the annular duct 11, around a central longitudinal axis AA′ to form an annular ionization and acceleration chamber 40 in the annular duct 11.

A propulsion-gas supply circuit 4 is positioned in a lower part of the body 10. The direction of injection of the gas is represented by an arrow at the inlet of the circuit in FIG. 1. The propulsion assembly comprises one or more gas inlet holes formed in the end wall of the annular duct and connected to the ionizable-gas supply circuit 4. The gas is introduced into the annular ionization and acceleration chamber 40 through the gas supply holes. By way of example, in FIG. 1, two supply holes 5 are depicted.

The polarization of each permanent magnet is chosen so as to create magnetic field lines 6, ensuring confinement of the electrons supplied by the cathode 8. Their geometrical configuration is responsible for the “magnetic lens” effect at the first end 2 of the annular duct 11. This specific configuration of magnetic field lines is referred to as a “magnetic lens” or “magnetic barrier”, which is essential to the mode of operation of a Hall-effect thruster and is responsible for ionizing the neutral atoms and accelerating the ions.

The thruster assembly further comprises an anode 9 positioned inside the annular duct 11, close to the end wall of the duct. The anode 9 generally has a function of diffusing the propulsion gas and may have a stepped structure as proposed in document U.S. Pat. No. 10,723,489B2. A hollow cathode 8 is situated outside the annular duct 11, at the open downstream first end 2 of the duct 11. The cathode is oriented toward the open first end of the duct in order to eject electrons toward the main axis AA′ and the region downstream of the open end of the duct. When a voltage is applied between the cathode and the anode, the low axial conductivity of the electrons, caused by their confinement within the “magnetic barrier”, generates an electric field in the ionization chamber 40 which extends axially with respect to the longitudinal axis AA′.

The operation of such a Hall-effect plasma thruster is briefly described below.

The electrons ejected by the hollow cathode 8 are partly directed toward the anode 9 and are firstly trapped and confined by the intense radial magnetic field in the vicinity of the first end 2 of the annular duct. The electrons then collide with the atoms or molecules constituting the propellant (injected in gaseous form from the end wall of the annular duct) and circulating from downstream to upstream of the duct to reach the anode 9. These electrons thus achieve partial or total ionization of the gas, and the mixture of ions and electrons then constitute the plasma state. On the other hand, the electrons trapped by the magnetic field create the axial electric field responsible for accelerating the ions between the anode and the exit of the duct, so that these ions are ejected from the duct at high speed, in an ejection direction mainly parallel to the longitudinal axis AA′, thus generating a thrust directed upstream. The direction of ion ejection is represented in FIG. 1 by arrows.

The use of electromagnetic coils and/or permanent magnets to form the magnetic circuits 20 generates a residual magnetic moment in the propulsion device. When such a plasma thruster is implemented in satellites, the residual magnetic moment of the thruster contributes to the overall residual magnetic moment of the satellite. In instances in which the thrusters are intended for satellites in low Earth orbit, the interaction between the Earth's magnetic field and the overall residual magnetic moment of the satellite is one of the main sources of disorientation and disturbance to the proper functioning of the satellite.

A first known solution consists in using electromechanical stabilization devices such as reaction wheels or gyroscopic actuators to readjust the attitude of the satellite. These devices make it possible to maintain control of the orientation of the satellite, but in a transient manner because it is necessary to dissipate the energy that they merely store temporarily. They are also a source of electrical power consumption. Traditionally, a satellite always has a magnetic orientation device known as a magneto-coupler which consists of a coil associated with an electrical power supply. This system is active only when the satellite is operational, consumes electricity and contributes significantly to the mass of the satellite. It is therefore necessary to reduce its size by limiting parasitic magnetic moments.

One solution consists in the use of magnetic field generating coils that compensate for the magnetic field of the thruster and thus minimize or even cancel the residual magnetic moment. Documents WO2019229286A1 and U.S. Pat. No. 10,752,385 present examples of this solution. However, this solution implies greater complexity in the electrical power supply as well as over-consumption of electricity.

In general, the cancelation, or at least the minimization, of the residual magnetic moment can be done by the addition of magnetic screening devices (shielding) and/or by the addition of magnetic compensation devices, which will be sized and sited in such a way as to minimize the residual magnetic moment. Such solutions are described in the following documents: M de Soria-Santacruz et al., “An Approach to Magnetic Cleanliness for the Psyche Mission”, (2020 IEEE Aerospace Conference, Big Sky, MT, USA, 2020, pp. 1-15), Noel Sebastian Janes, “Small Satellite Design for High Sensitivity Magnetic Measurements”, A. Lassakeur and C. Underwood, “Magnetic Cleanliness Program on CubeSats for Improved Attitude Stability”, (2019 9th International Conference on Recent Advances in Space Technologies (RAST), Istanbul, Turkey, 2019, pp. 123-129).

Document WO2021201871A1 describes a Hall-effect thruster assembly which comprises a Hall-effect thruster and a mounting assembly coupled to one end of the Hall-effect thruster. The mounting assembly is configured to support the Hall-effect thruster and to attach the Hall-effect thruster to a spacecraft. The mounting assembly includes a plurality of magnetic elements, which may be electromagnetic coils or permanent magnets, able to produce a magnetic dipole moment to attenuate or reduce the magnetic moment of the Hall-effect thruster. The magnetic elements are positioned away from the Hall-effect thruster so as not to disturb the magnetic field generated by the magnetic circuit near the ion ejection end of the thruster.

Such a solution is not entirely satisfactory. The magnets that form the magnetic circuit of the thruster are close to the ionization chamber and thus experience significant heating. The walls forming the ionization chamber can generally reach over 300° C., and the magnets over 200° C. The magnetic properties of the magnets, especially their remanence, can change with temperature. The remanence and therefore the residual magnetic moment is different depending on whether the thruster is on, and therefore hot, or off, and therefore cold. Furthermore, this remanence can decrease irreversibly over time. Having one or more compensation magnets sited in locations distant from the ionization chamber, and therefore in a region that is colder, does not make it possible to take this temperature-dependency of the remanence of the main magnets into consideration. The compensation produced by the compensation magnets is therefore not perfect.

Furthermore, the compactness of such a Hall-effect thruster is not optimal because it requires a mounting assembly to support the compensation magnets.

An object of the present disclosure is to propose a plasma thruster that is able to overcome the drawbacks of the prior art and in particular offers a solution that is simple to implement for compensating for the residual magnetic moment resulting from the magnetic circuit of the thruster, while maintaining an optimal configuration of the magnetic field generated by the magnetic circuit so as to guarantee the performance of the thruster and the lifetime of the latter.

### SUMMARY

The present disclosure improves the situation.

What is proposed is a hall-effect propulsion system comprising:
a support body extending between a first end and a second end, said body comprising an annular external wall and an annular internal wall arranged coaxially about a longitudinal axis AA′ to form an annular duct, said first end having an annular opening forming an ion outlet;
a magnetic circuit arranged in the annular duct and configured to generate a radial magnetic barrier in the annular duct near the first end of the duct;
at least one magnetic compensation magnetic element arranged in said magnetic circuit and configured to compensate at least a fraction of an absolute value of the residual magnetic moment generated by said magnetic circuit.

According to one embodiment, the magnetic circuit comprises at least one high positive magnetic susceptibility element and at least one magnetic field generating magnetic element, these being configured to generate said radial magnetic barrier, said at least one magnetic compensating element being positioned in the magnetic circuit such that it is further distant from the first end than said at least one magnetic field generating magnetic element.

According to one embodiment, said at least one magnetic compensation magnetic element has a continuous annular shape.

Alternatively, said at least one magnetic compensation magnetic element comprises a plurality of discrete magnetic elements positioned circumferentially with respect to the longitudinal axis AA′.

In another embodiment, said at least one high positive magnetic susceptibility element comprises a plurality of high positive magnetic susceptibility external elements arranged against the annular external wall, said magnetic compensation magnetic element being held in position between two high positive magnetic susceptibility external elements.

In yet another embodiment, said at least one high positive magnetic susceptibility element comprises a plurality of high positive magnetic susceptibility external elements arranged against the annular external wall, at least one external element of the plurality of high positive magnetic susceptibility external elements being equipped with a housing adapted to receive said at least one magnetic compensating element.

The features described in the following paragraphs may optionally be implemented independently of each other or in combination with each other:
Said at least one magnetic compensation element is made of a material chosen from the following materials: neodymium-iron-boron, samarium-cobalt or hexaferrites.

The at least one magnetic compensation element is in the form of a magnetic coil or a permanent magnet.

According to one embodiment, the device further comprises a gas-supply circuit configured to inject an ionizable gas into the annular duct.

According to another embodiment, the device further comprises an electrical circuit configured to generate an electric field in a portion of the annular duct, said electrical circuit comprising an annular anode arranged inside the annular duct and at least one cathode arranged outside the annular duct, near the first end of the annular duct.

Preferably, said at least one magnetic compensation magnetic element is configured such that the absolute value of the residual magnetic moment of the circuit is at least less than 0.1 A.m² over a temperature range comprised between 50° C. and 250° C.

### BRIEF DESCRIPTION OF DRAWINGS

Other features, details and advantages will appear from reading the detailed description below, and from analyzing the appended drawings, in which:

FIG. 1 schematically depicts a view, in cross section, of a Hall-effect plasma thruster according to the prior art.

FIG. 2 schematically depicts a view, in cross section, of a Hall-effect plasma thruster according to one embodiment.

FIG. 3 schematically depicts a view, in cross section, of the magnetic circuit of the Hall-effect plasma propulsion device without the support body of FIG. 2.

FIG. 4 schematically depicts a view, in cross section, of the magnetic circuit of the Hall-effect plasma propulsion device according to another embodiment without the support body of FIG. 2.

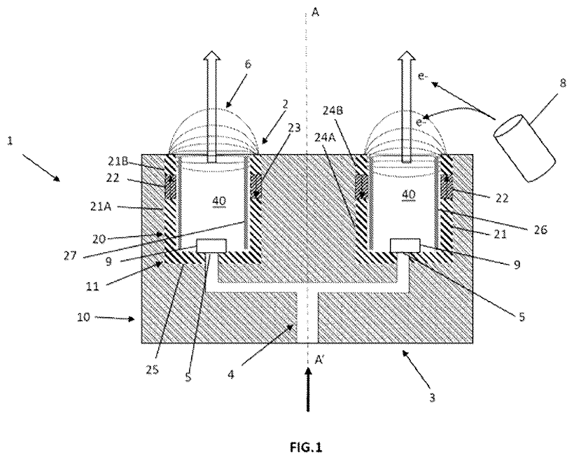

### DETAILED DESCRIPTION

A Hall-effect ion ejection device according to one embodiment applied to a Hall-effect plasma thruster will be described below.

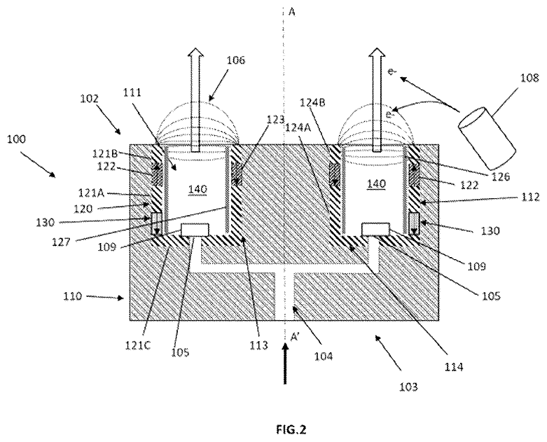

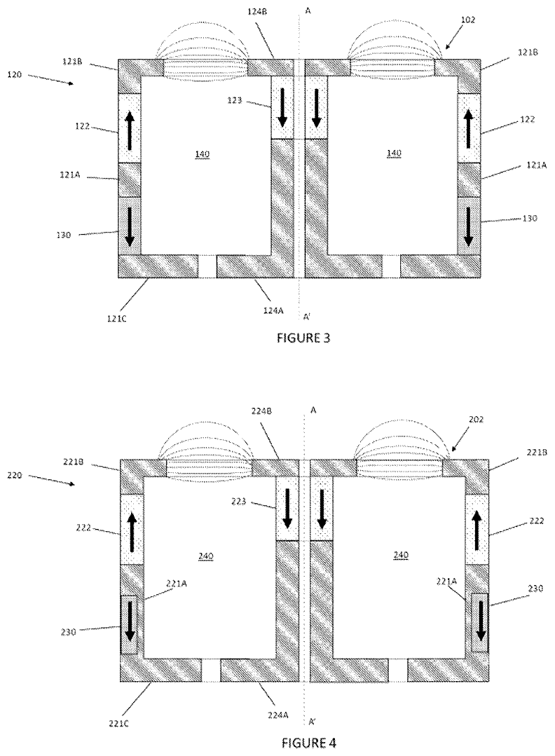

The Hall-effect propulsion device 100 according to one embodiment is described below with reference to FIG. 2 and FIG. 3.

The propulsion device 100 comprises a support body 110 and a magnetic circuit 120.

The support body 110 has a shape exhibiting symmetry of revolution about a longitudinal axis AA′. The body 110 comprises an annular external wall 112, an annular internal wall 113 and an end wall 114 connecting the two walls. The external wall 112 and the internal wall 113 are arranged coaxially about the longitudinal axis AA′. The external and internal walls and the end wall form an annular duct 111. The magnetic circuit 120 is housed in the annular duct 111.

The propulsion assembly comprises a first end 102 having an annular opening, and a second end 103.

The propulsion device comprises a propulsion-gas supply circuit 104 positioned in a lower part of the support body 110. The direction of injection of the gas is represented by an arrow at the inlet of the circuit in FIG. 2. The propulsion device comprises one or more gas inlet holes 105 formed in the end wall of the annular duct and connected to the ionizable-gas supply circuit 4. The gas is introduced into the annular duct 111 through the gas supply holes. The propulsion gas may, for example, be xenon, argon or krypton capable of being ionized. By way of example, in FIG. 2, two supply holes 105 are depicted.

An outer protective wall 126 and an inner protective wall 127 are disposed in the annular duct 111, respectively facing the annular external wall 112 and the annular internal wall 113. These protective walls 126 and 127 are typically made of a ceramic material and protect the external annular wall 112 and internal annular wall 113 against erosion.

Alternatively, a solid-propellant source may be used instead of a gas. The gas-supply circuit 4 is in this case replaced by a solid propellant placed in or upstream of the acceleration duct. The solid material is heated so that it passes directly into the vapor phase (by sublimation of the material) so that the particles are then ionized and accelerated in the duct.

For the purposes of this disclosure, the terms “upstream” and “downstream” are defined with respect to the normal direction of flow of the gas which is in the same direction as the ejection of ions, from upstream to downstream through the annular space 140 delimited by the outer protective wall 126 and the inner protective wall 127.

For the purposes of this disclosure, the term “internal” refers to a part of the device close to the central longitudinal axis AA′ while the term external refers to a part of the device further distant from the central longitudinal axis AA′.

The Hall-effect propulsion device also comprises a magnetic circuit 120 configured to generate a radial magnetic field in the annular duct 111, the intensity of which field is maximal near the first end of the annular duct, namely at the annular opening of the device 102.

The magnetic circuit 120 is formed by a plurality of high positive magnetic susceptibility elements 121A, 121B, 121C, 124A, 124B and a plurality of magnetic field generating magnetic elements 122, 123 arranged in the annular duct 111 and configured to generate the radial magnetic barrier in the annular duct 111. The magnetic elements are arranged concentrically about the longitudinal central axis AA′ to form an annular ionization and acceleration chamber 140 in the annular duct 111 of the support body 110.

The high positive magnetic susceptibility elements 121A, 121B, 121C, 124A, 124B and the magnetic field generating magnetic elements 22, 23 are designed to form a magnetic circuit capable of generating the radial magnetic field in the ionization chamber 140, of which field the intensity in the axial direction (parallel to AA′) is maximal near the first end 102, at the annular opening. The high positive magnetic susceptibility elements are selected and designed to guide and ensure continuity of the magnetic field lines.

The propulsion device comprises one or more magnetic compensation magnetic elements 130 arranged in the magnetic circuit 120 and designed to compensate at least a fraction of the residual magnetic moment generated by the magnetic circuit 120. The magnetic compensating elements 130 are positioned in the magnetic circuit 120 so that they are further distant from the first end 102 than the magnetic field generating magnetic elements 122, 123. They are positioned near the end wall of the annular duct so as not to affect the magnetic lenses formed at the first end of the device.

According to one embodiment, the magnetic field generating magnetic elements 122, 123 and the magnetic compensating elements 130 may have a continuous annular shape. This annular continuous shape is particularly suitable for a small-sized propulsion device.

According to another embodiment, the magnetic field generating magnetic elements 122, 123 and the magnetic compensating elements 130 are formed by a plurality of discrete magnetic elements positioned circumferentially with respect to the longitudinal axis AA′. They are, for example, in the form of arc segments.

The use of discrete magnetic compensating elements makes it easier to adjust the volume of the compensating magnets needed to compensate for the residual magnetic moment. They are more suitable for a large-sized propulsion device.

The magnetic field generating magnetic elements 122, 123 and the magnetic compensating elements 130 may be magnetic coils. Alternatively, they may be permanent magnets.

According to one exemplary embodiment as illustrated in FIG. 3, the magnetic circuit 120 comprises an external part and an internal part. The external part comprises three high positive magnetic susceptibility elements 121A, 121B, 121C, a magnetic field generating external element 122, and a magnetic compensating element 130, these being arranged against the external wall of the annular duct 111 which can be seen in FIG. 2. The internal part comprises two high positive magnetic susceptibility internal elements 124A, 124B and a magnetic field generating internal element 123, these being arranged against the internal wall of the annular duct 111. The magnetic compensating elements 130 are held in position between two high positive magnetic susceptibility external elements 121A, 121C and arranged in the magnetic circuit so as to be further distant from the first end 102 forming the ion ejection outlet than the magnetic field generating external element 122. The high positive magnetic susceptibility elements, which are made of soft iron material, are naturally attracted to the other elements of the magnetic circuit that are the permanent magnets.

The polarization of each permanent magnet is chosen so as to create magnetic field lines 106, ensuring the confinement of the electrons supplied by the cathode 108 within the magnetic barrier 106 or “magnetic lens” produced at the first end of the annular duct, as illustrated in FIG. 3.

According to one exemplary embodiment, the thruster comprises an electrical circuit comprising an annular anode 109 situated on the end wall of the annular duct and a hollow cathode 108 situated at the open upstream end of the duct. The cathode 108 is oriented toward the first end 102 in order to eject electrons in the direction of the main axis AA′ and of the region situated downstream of the first end. When a voltage is applied between the cathode and the anode, an electric field is generated in the ionization chamber 140 and extends axially with respect to the longitudinal axis AA′.

According to another exemplary embodiment of the magnetic circuit and with reference to FIG. 4, the magnetic circuit 220 comprises an external part and an internal part. The external part comprises a high positive magnetic susceptibility upper external element 221B, a high positive magnetic susceptibility lower external element 221C and a magnetic field generating external element 222, these being arranged against the external wall of the annular duct 111 which can be seen in FIG. 2. The magnetic field generating external element 222 is interposed between the upper and lower external elements 221B, 221C and close to the first end 202 forming the ion ejection outlet. The inner part comprises a high positive magnetic susceptibility upper internal element 224B, a high positive magnetic susceptibility lower internal element 224A and a magnetic field generating internal element 223, these being arranged against the internal wall of the annular duct 111. The magnetic field generating internal element 223 is interposed between the two, upper and lower, internal elements 224B, 224A and close to the first end 202 forming the ion ejection outlet. The high positive magnetic susceptibility lower external element 221C of the external part of the magnetic circuit comprises a housing adapted to house a magnetic compensating element 230.

In instances in which the magnetic compensating element 230 has a continuous annular shape about the longitudinal axis AA′, the housing is formed by a continuous groove made in the thickness of the lower external element 221C. The size and shape of the groove are adapted to house the magnetic compensating element.

In instances in which the magnetic compensating element 230 is formed by a plurality of discrete magnetic elements positioned circumferentially with respect to the longitudinal axis AA′, the housing is formed by a plurality of grooves made in the thickness of the lower external element 221C to each house a discrete magnetic element.

According to the present disclosure, the magnetic compensation element 130 is configured to compensate for the residual magnetic moment resulting from all the magnetic elements forming the magnetic circuit 120 of the propulsion device.

The magnetic compensation element 130 is arranged in the magnetic circuit 120 so as not to disturb the magnetic field lines 106 formed by the magnetic circuit near the first end 102, at the outlet of the duct. Specifically, and in order to keep the performance of a compensated magnetic thruster the same as that of a non-compensated magnetic thruster, it is essential to keep the magnetic topologies with and without magnetic compensation 130 similar.

The volume of the magnetic compensation element is determined so that the residual magnetic moment resulting from all the magnetic elements forming the magnetic circuit 120 of the thruster is at least less than 0.1 A.m².

The method for calculating the volume of all compensating magnets is described below.

In a first step E1, the (total) residual magnetic moment is calculated as the integral of the magnetization (the magnetic moment volume density) in the volume of all magnetic elements, whether they are sources or conductors of the associated field.

In a second step E2, the residual magnetic moment is calculated for all the magnetic elements forming the initial magnetic circuit.

In a third step E3, the total volume of magnet(s) necessary for compensating the magnetic moment is estimated.

In a fourth step E4, the (total) residual magnetic moment is calculated with the magnetic compensation magnet(s) integrated into the initial magnetic circuit.

In a fifth step E5, steps E2 to E4 are repeated so that the residual moment of the overall circuit of the thruster is at least less than 0.5 A.m² and ideally less than 0.1 A.m².

According to one embodiment, the compensation magnets may be made of a magnetic material such as neodymium-iron-boron or samarium-cobalt alloys or with hard ferrites called hexaferrites.

The fact that the magnetic compensating element is integrated directly into the magnetic circuit has made it possible to improve the compactness of the Hall-effect propulsion device compared to known solutions.

Since the magnetic compensating elements are placed close to the magnetic field generating magnetic elements, and in particular in thermal contact via a common component having good thermal conductivity, for example in FIG. 3, via the high positive magnetic susceptibility external element 121A, they therefore experience the same thermal operating conditions as the magnetic field generating magnetic elements and their remanence evolves in an identical manner to that of the magnetic field generating magnetic elements, thus making it possible to compensate effectively the residual magnetic moment of the magnetic circuit, whatever the temperature of the magnetic field generating magnetic elements. As a result, the compensation of the residual magnetic moment remains optimal regardless of the thermal status of the device.

For example, residual magnetic moment (RMM) calculations were performed for two thermal conditions and in two magnetic situations (with magnetic compensation external to or included in the magnetic circuit, as described above).

In a first situation with external magnetic compensation (and therefore with different temperatures between the magnetic circuit and the compensating magnet(s)), the magnetic moment changes from −14 mA.m² (for a magnetic circuit and compensating magnets at 20° C.), up to +126 mA.m² for a magnetic circuit at 200° C. and compensating magnets at 20° C.

In a second situation with magnetic compensation included in the magnetic circuit (and therefore similar temperatures between the magnetic circuit and the compensating magnet(s)), the magnetic moment changes from −1 mA.m² (for all of the magnetic elements at 20° C.) to −28 mA.m² (for all of the magnetic elements at 200° C.).

Note that the positive or negative value of the RMM is not necessarily to be considered in the “magnetic compensation” because the sign of the RMM will correspond to the direction of rotation of the satellite (on which the Hall-effect thruster is mounted) orbiting the Earth. In general, the limit value for the RMM depends on the type of mission for which the satellite is intended, but it is generally considered satisfactory to obtain an RMM of less than 100 mA.m² in order to limit the effects of the Earth's magnetic field. Comparing these two cases, it will be noted that the compensation cannot be this optimal unless all the magnetic elements of the thruster are under the same thermal conditions.

If the magnetic compensating elements operate at different temperature conditions than the magnetic field generating magnetic elements, the calculation steps described above should ideally be carried out taking into account the properties of the materials, notably their magnetic properties, at a temperature typical of thruster operation, so as to minimize the residual moment when the thruster is in operation. Alternatively, the calculation could aim at minimizing the magnetic moment of the thruster when it is not in use, as this may represent the majority of its lifetime. It would also be possible to elect to minimize the residual moment for an intermediate temperature somewhere between the operating temperature and the non-operational temperature, so as to minimize the overall perturbation, during the life of the thruster, for example, by weighting the temperature by the proportion of the lifetime spent at said temperature.

When implementing such a thruster in satellites, it is no longer necessary to calculate the residual magnetic moment by including the thruster magnetic circuit, thus simplifying the process of implementing the thruster in the satellite. The thruster is self-compensating. The residual magnetic moment of the satellite can therefore be calculated and compensated independently of the choice and position of the thruster and before the installation of the propulsion device.

The technical solution proposed in the present disclosure is particularly suitable for compensating the residual magnetic moment resulting from the magnetic circuit of a Hall-effect plasma thruster using permanent magnets. However, the proposed technical solution can be applied to other types of thrusters, notably electrothermal thrusters such as arc-jet thrusters, magnetoplasmadynamic thrusters, gridded thrusters, ECR thrusters, and vacuum arc thrusters, coming under the category of solid-state propulsion systems.

What is claimed is:

1. A Hall-effect propulsion device comprising:
a support body extending between a first end and a second end said body comprising an annular external wall and an annular internal wall arranged coaxially about a longitudinal axis AA′ to form an annular duct, said first end having an annular opening forming an ion outlet;
a magnetic circuit arranged in the annular duct and configured to generate a radial magnetic barrier in the annular duct near the first end of the duct; and
at least one magnetic compensation magnetic element arranged in said magnetic circuit and configured to compensate at least a fraction of an absolute value of the residual magnetic moment generated by said magnetic circuit.

2. The device as claimed in claim 1, wherein the magnetic circuit comprises at least one high positive magnetic susceptibility element and at least one magnetic field generating magnetic element, these being configured to generate said radial magnetic barrier, said at least one magnetic compensating element being positioned in the magnetic circuit such that it is further distant from the first end than said at least one magnetic field generating magnetic element.

3. The device as claimed in claim 1, wherein said at least one magnetic compensation magnetic element has a continuous annular shape.

4. The device as claimed in claim 1, wherein said at least one magnetic compensation magnetic element comprises a plurality of discrete magnetic elements positioned circumferentially with respect to the longitudinal axis AA′.

5. The device as claimed in claim 2, wherein said at least one high positive magnetic susceptibility element comprises a plurality of high positive magnetic susceptibility external elements arranged against the annular external wall, said magnetic compensation magnetic element being held in position between two high positive magnetic susceptibility external elements.

6. The device as claimed in claim 2, wherein said at least one high positive magnetic susceptibility element comprises a plurality of high positive magnetic susceptibility external elements arranged against the annular external wall, at least one external element of the plurality of high positive magnetic susceptibility external elements being equipped with a housing adapted to receive said at least one magnetic compensating element.

7. The device as claimed in claim 1, wherein said at least one magnetic compensation element is made of a material chosen from the following materials: neodymium-iron-boron, samarium-cobalt or hexaferrites.

8. The device as claimed in claim 1, wherein said at least one magnetic compensating element is in the form of a magnetic coil or of a permanent magnet.

9. The device as claimed in claim 1, further comprising a gas-supply circuit configured to inject an ionizable gas into the annular duct.

10. The device as claimed in claim 1, further comprising an electrical circuit configured to generate an electric field in a portion of the annular duct, said electrical circuit comprising an annular anode arranged inside the annular duct and at least one cathode arranged outside the annular duct, near the first end of the annular duct.

11. The device as claimed in claim 1, wherein said at least one magnetic compensation magnetic element is configured such that the absolute value of the residual magnetic moment of the circuit is at least less than 0.1 A.m² over a temperature range comprised between 50° C. and 250° C.
